(19) United States
(12) Patent Application Publication
(10) Pub. No.: US 2024/0297604 A1
(43) Pub. Date: Sep. 5, 2024

(54) DEVICE FOR THE DE-EXCITATION OF AT LEAST ONE ROTOR WINDING OF A SYNCHRONOUS MOTOR, SYNCHRONOUS MOTOR, METHOD FOR OPERATING A SYNCHRONOUS MOTOR, MOTOR VEHICLE

(71) Applicant: ZF Friedrichshafen AG, Friedrichshafen (DE)

(72) Inventor: Sebastian Wendel, Arnstein (DE)

(73) Assignee: ZF Friedrichshafen AG, Friedrichshafen (DE)

(21) Appl. No.: 18/591,285

(22) Filed: Feb. 29, 2024

(30) Foreign Application Priority Data
Mar. 3, 2023 (DE) 102023201934.5

(51) Int. Cl. H02P 27/05; B60L 15/20

(52) U.S. Cl. CPC H02P 27/05; B60L 15/20

(57) ABSTRACT

A device for the de-excitation of at least one rotor winding of an externally electrically excited synchronous motor has a stator current controller. The stator current controller is designed to inject a stator current value into a stator current in such a manner that a value of an Id stator current following deactivation of the synchronous motor has a predefined positive value and is higher than the Id stator current prior to deactivation.

### CROSS-REFERENCE TO RELATED APPLICATION

This application claims priority to German Application No. 10 2023 201 934.5, filed on Mar. 3, 2023, the entirety of which is hereby fully incorporated by reference herein.

### FIELD

The present disclosure relates to a device for the de-excitation of at least one rotor winding of a synchronous motor, a synchronous motor, a method for operating a synchronous motor and to a motor vehicle.

### BACKGROUND

DE 10 2018 201 321 A1 discloses a method for operating an arrangement made from an electric motor and a rectifier.

### SUMMARY

Against this background, the present disclosure creates an improved device for the de-excitation of at least one rotor winding of a synchronous motor, an improved synchronous motor, an improved method for operating a synchronous motor and an improved motor vehicle according to the present disclosure. Advantageous embodiments also emerge from the following description.

The advantages that can be achieved using the approach presented here consist in particular in a device being created which can enable reliable and fast de-excitation of at least one rotor winding of a synchronous motor.

A corresponding device for the de-excitation of at least one rotor winding of an externally electrically excited synchronous motor has a stator current controller. The stator current controller is designed to inject a stator current value into a stator current in such a manner that a value of an Id stator current following deactivation of the synchronous motor has a predefined positive value and is higher than the Id stator current prior to deactivation.

The externally electrically excited synchronous motor may be an electric motor for driving a motor vehicle. The stator current controller can generate or adjust the stator current, for example the Id stator current. When the synchronous motor is deactivated, the synchronous motor may change to a generative mode. In this state, the at least one rotor winding can be de-excited using the Id stator current that is predefined or is to be actively adjusted. Considerably faster de-excitation of the rotor current can be achieved by the active adjustment of the Id stator current than would be the case if the stator current were to be left to freewheel. The approach that is presented here can therefore also be understood as fast rotor de-excitation of the electrically excited synchronous motor or as fast de-excitation of the rotor winding of the electrically excited synchronous motor. The electrically excited synchronous motor can also be referred to in an abbreviated manner as EESM. The approach presented here may allow overvoltage and overcurrent prevention of the electrically excited synchronous motor in a fault case. A fault case may for example be load shedding of the battery at the generative corner point, an active short circuit, abbreviated to ASC, and/or inverter lockout, abbreviated IL.

The stator current controller may be designed to inject the stator current in such a manner that the value of the Id stator current can lie in a tolerance range of 50 percent of the maximum possible Id stator current value. In this case, the value of the Id stator current can in particular lie in a tolerance range of 10 percent of the maximum possible Id stator current value. In this case, the value of the Id stator current can in particular be set to the maximum possible Id stator current value. Advantageously, the at least one rotor winding can be de-excited reliably and fast if the stator current is injected at a high Id stator current value. The higher or more positive the value of the Id stator current is, the faster the rotor winding can be de-excited.

The stator current controller can be designed to inject a stator current value into the stator current in such a manner that a value of the Iq stator current can have a value of 0 ampere within a tolerance range following deactivation of the synchronous motor. The Iq stator current can be adjusted from a negative value to the value 0 ampere following the deactivation of the synchronous motor. This can have an advantageous effect on the de-excitation of the rotor winding.

The device can have a rotor current controller which may be designed to actively short circuit a rotor current of a rotor of the synchronous motor following deactivation of the synchronous motor. Short circuiting the rotor current can advantageously affect the rate of the de-excitation.

The stator current controller can be designed to activate an inverter lockout mode following deactivation of the synchronous motor. An inverter lockout mode can be understood to mean a state in which a power inverter is locked out, so no electric power is transported or transferred via the power inverter. For example, an inverter lockout of this type may be achieved in that all switching elements of the power inverter are opened. Such switching on of the inverter lockout may accelerate a de-excitation of the electric motor.

The device can have a discharge resistance device which is connected between two terminals of a DC link of the synchronous motor in order to cause a discharge current between the terminals of the DC link via a discharge resistor if a voltage between the two terminals exceeds a threshold value. Therefore, damage to the device can be avoided or prevented. The discharge resistor can be produced inexpensively.

The discharge resistance device can be designed to suppress and additionally or alternatively to prevent the discharge current in the event of the voltage between the terminals falling short. Thus, an active short circuit can be actuated merely for scenarios in which there is a fear of damage to components of the devices that are used here.

The discharge resistance device can have switching equipment which can be connected in series with the discharge resistor. The switching equipment can be produced inexpensively and fast.

The switching equipment may have a MOSFET semiconductor component and a comparator circuit, a thyristor, an IGBT and additionally or alternatively a Zener diode. Also, the advantages of the approach described here can be realized very efficiently by means of an embodiment of this type.

An externally electrically excited synchronous motor has an embodiment of a device that is mentioned herein. In this case, a rotor of the synchronous motor in particular is or can be inductively or conductively electrically coupled or can be inductively or conductively electrically supplied. Also, the advantages of the approach described here can be realized very efficiently by means of an embodiment of this type.

Moreover, the present disclosure relates to a power converter, particularly a power inverter, for a motor vehicle having an embodiment of a device that is mentioned herein.

Moreover, the present disclosure relates to an electric final drive for a motor vehicle having at least one electric motor, a transmission device and an embodiment of a power converter that is described herein.

An electric alternating current that is required for operating the electric motor can be provided using the power inverter. A torque that is provided by the electric motor can be converted into a driving torque for driving at least one wheel of the motor vehicle using the transmission device. The transmission device may have a transmission for reducing the speed of the electric motor and optionally a differential gear.

Moreover, the present disclosure relates to a motor vehicle having an embodiment of a power converter that is mentioned herein and additionally or alternatively having an embodiment of an electric final drive that is mentioned herein and additionally or alternatively having an embodiment of a device that is mentioned herein. The motor vehicle may additionally have an embodiment of an externally electrically excited synchronous motor that is mentioned herein.

A method for operating an embodiment of an externally electrically excited synchronous motor that is mentioned herein comprises an injection step. In the injection step, a stator current is injected at a stator current value in such a manner that a value of an Id stator current following deactivation of the synchronous motor has a predefined positive value that is higher than the Id stator current prior to deactivation.

A computer program product or computer program is also advantageous, having program code that can be stored on a machine-readable carrier or storage medium, such as a semiconductor memory, a hard disk drive or an optical storage medium, and is used for carrying out, implementing and/or activating the steps of the method according to one of the previously described embodiments, particularly if the program product or program is executed on a computer or a device.

The present disclosure is explained in more detail by way of example with reference to the attached drawings.

### BRIEF DESCRIPTION OF THE DRAWINGS

FIG. 1 shows a circuit diagram of an exemplary embodiment of a device for a synchronous motor;

FIG. 2 shows a circuit diagram of an exemplary embodiment of a device for a synchronous motor;

FIG. 3 shows an illustration of a discharge resistance device for an exemplary embodiment of a device;

FIG. 4 shows an illustration of a diode circuit for an exemplary embodiment of a device;

FIG. 5 shows a graph for illustrating signal curves to explain an exemplary embodiment of a device;

FIG. 6 shows a graph for illustrating signal curves to explain an exemplary embodiment of a device;

FIG. 7 shows a graph for illustrating signal curves to explain an exemplary embodiment of a device;

FIG. 8 shows a graph for illustrating signal curves to explain an exemplary embodiment of a device;

FIG. 9 shows a schematic illustration of an exemplary embodiment of a motor vehicle; and

FIG. 10 shows a flowchart of an exemplary embodiment of a method for operating a synchronous motor.

### DETAILED DESCRIPTION

In the following description of preferred exemplary embodiments of the present disclosure, the same or similar reference signs are used for the elements which are illustrated in the various figures and act similarly, wherein a repeated description of these elements is dispensed with.

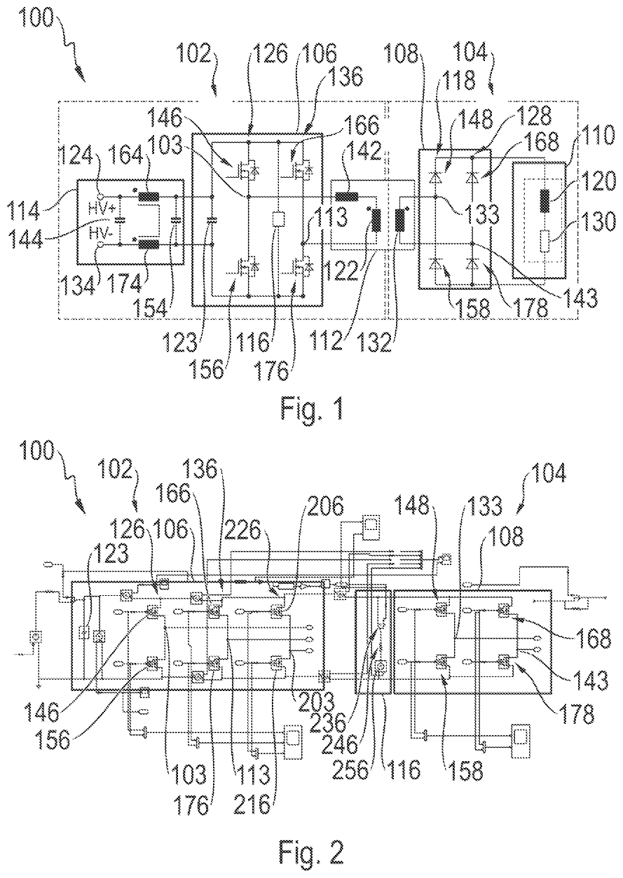

FIG. 1 shows a circuit diagram of an exemplary embodiment of a device 100 for a synchronous motor. In other words, FIG. 1 shows a circuit for an inductive exciter. The device 100 is designed for example to de-excite at least one rotor winding 110 of the synchronous motor. The synchronous motor is designed merely by way of example as an externally electrically excited synchronous motor and is part of a motor vehicle, in order to drive the motor vehicle. De-excitation of the rotor winding 110 is important for example in a fault case of the synchronous motor, in order to avoid damage to the device 100. It is true in this case that: the faster the rotor winding 110 is de-excited, the faster the synchronous motor or the motor vehicle is in a safe state.

The device 100 has a stator current controller 102 and according to an exemplary embodiment additionally a rotor current controller 104 and a discharge resistance device 116. The stator current controller 102 may also be termed a stator and the rotor current controller 104 may also be termed a rotor. The stator current controller 102 has, merely by way of example, a bridge circuit unit 106, wherein the discharge resistance device 116 is for example connected inside the bridge circuit unit 106. In addition, the stator current controller 106 has a filter device 114 and, at least to some extent, a transformer device 112. The rotor current controller 104 has, merely by way of example, a further bridge circuit unit 108, the at least one rotor winding 110 and, at least to some extent, the transformer device 112.

According to an exemplary embodiment, the device 100 has a first supply voltage terminal 124 and a second supply voltage terminal 134 for applying a DC supply voltage. An energy storage device 144, here a capacitor, is for example connected between the first supply voltage terminal 124 and the second supply voltage terminal 134. For example, a high-voltage battery can be connected to the supply voltage terminals 124, 134. A second energy storage device 154 is for example connected between the supply voltage terminals 124, 134. The supply terminals 124, 134 and the energy storage devices 144, 154 are part of the filter device 114 merely by way of example, which filter device may also be termed an EMI filter. According to an exemplary embodiment, the filter device 114 has two inductors 164, 174 that are connected between the energy storage devices 144, 154. In this case, the inductor 164 is connected between a first pick-off point of the energy storage device 144 and a second pick-off point of the second energy storage device 154. The further inductor 174 is connected between a further first pick-off point of the energy storage device 144 and a further second pick-off point of the second energy storage device 154. The filter device 114 is for example designed to reduce electromagnetic high-frequency disturbances that are transmitted through the lines and can cause interference with other devices.

The bridge circuit unit 106 is for example designed to convert the DC supply voltage into an AC supply voltage. The AC supply voltage is subsequently converted by the transformer device 112 into an AC output voltage, wherein the further bridge circuit unit 108 converts the AC output voltage into the DC output voltage. According to an exemplary embodiment, the bridge circuit unit 106 is designed as a H-bridge and may also be termed a H-bridge. To this end, the bridge circuit unit 106 for example has a first half bridge 126 and a second half bridge 136. The first half bridge 126 has a first switch 146 and a second switch 156, wherein the switches 146, 156 are connected to one another via a first pick-off point 103. The first switch 146 is connected by way of example between the first supply voltage terminal 124 and the first pick-off point 103 and the second switch 156 is connected between the second supply voltage terminal 134 and the first pick-off point 103. The second half bridge 136 has a third switch 166 and a fourth switch 176, wherein the switches 166, 176 are connected to one another via a second pick-off point 113. The third switch 166 is connected by way of example between the first supply voltage terminal 124 and the second pick-off point 113 and the fourth switch 176 is connected between the second supply voltage terminal 134 and the second pick-off point 113. The switches 146, 156, 166, 176 are formed as transistors for example. Each of the transistors for example comprises a control input and a first switch input and a second switch input, wherein a current flow between the switch inputs can be controlled by a switch signal that is applied at the control input. The pick-off points 103, 113 are designed to output the AC supply voltage for example.

According to an exemplary embodiment, a third energy storage device 123 is connected between the supply terminals 124, 134 and the first half bridge 126. According to an exemplary embodiment, the discharge resistance device 116 is connected between the half bridges 126, 136.

The transformer device 112 is connected by way of example between the bridge circuit unit 106 and the further bridge circuit unit 108 and can also be termed a rotary transformer. The transformer device 112 has a first inductor 122 and a second inductor 132 for converting the AC supply voltage into the AC output voltage, wherein the inductors 122, 132 are for example coupled via a common core for conducting a magnetic field. In order to convert the AC supply voltage into the AC output voltage, which differs from the AC supply voltage with respect to a size of the electric voltage, the inductors 122, 132 can differ in terms of the number of their windings. In this case, the first inductor 122 is connected via a first contact to the first pick-off point 103 and via a second contact to the second pick-off point 113. According to an exemplary embodiment, a further inductor 142 is connected between the first contact and the first pick-off point 103.

The further bridge circuit unit 108 can for example be designed as a rectifier and can therefore also be termed a rectifier. The further bridge circuit unit 108 for example has a third half bridge 118 and a fourth half bridge 128. The third half bridge 118 has a first diode 148 and a second diode 158, wherein the diodes 148, 158 are connected to one another via a third pick-off point 133. The fourth half bridge 128 has a third diode 168 and a fourth diode 178, wherein the diodes 168, 178 are connected to one another via a fourth pick-off point 143.

The second first inductor 132 of the transformer device 112 is connected via a further first contact to the third pick-off point 133 and via a further second contact to the fourth pick-off point 143.

The at least one rotor winding 110, which can also be termed rotor windings, is for example connected adjacent to the further bridge circuit unit 108 and has an inductor 120 and a resistor 130. The inductor 120 and the resistor 130 are connected in series in this case.

The stator current controller 102 is designed to generate a stator current, the rotor current controller 104 generates a rotor current. When the synchronous motor is deactivated, the stator current is injected with a positive stator current value, so that the rotor current or the rotor winding 110 is de-excited fast as a function of the positive stator current value of the stator current. The discharge resistance device 116 can additionally optionally be switched on during the de-excitation in order to cause a discharge current if a voltage of the stator current exceeds a threshold value.

FIG. 2 shows a circuit diagram of an exemplary embodiment of a device 100 for a synchronous motor. In this case, the device 100 resembles or corresponds to the device from FIG. 1, with the exception that only the stator current controller 102, the rotor current controller 104 and the discharge resistance device 116 are shown. In this case, the discharge resistance device 116 is connected merely by way of example between the stator current controller 102 and the rotor current controller 104. In other words, FIG. 2 shows power electronics, wherein the stator current controller 102 can also be termed stator power electronics and the rotor current controller 104 can be termed exciter power electronics. The discharge resistance device 116 can also be termed a switchable discharge resistor.

The stator current controller 102 has the bridge circuit unit 106, which additionally has a further half bridge 226 in FIG. 2 however. In this case, the further half bridge 226 has a further switch 206 and an additional switch 216, wherein the switches 206, 216 are connected to one another via a further pick-off point 203. The switches 146, 156, 166, 176, 206, 216 of the bridge circuit unit 106 are designed as MOSFET switches merely by way of example.

According to an exemplary embodiment, the discharge resistance device 116 has switching equipment 236 and a discharge resistor 246, wherein the switching equipment 236 and the discharge resistor 246 are connected in series. In this case, the switching equipment 236 is connected via a pick-off point to the stator current controller 102 and the rotor current controller 104. The discharge resistor 246 is likewise connected to the stator current controller 102 and the rotor current controller 104 via a further pick-off point.

The rotor current controller 104 has the further bridge circuit unit 108, wherein in FIG. 2 however, the switches 148, 158, 168, 178 are designed as transistors, merely by way of example as MOSFET switches.

In an operational state of the device 100, an Id stator current and an Iq stator current flow through the stator current controller 102. In the rotor current controller 104, a rotor current flows, which can also be termed an lexc rotor current. The rotor current is designed to energize or drive at least one rotor winding of the synchronous motor. It is important in certain situations that the rotor current is de-excited as fast as possible, for example in a fault case of the synchronous motor and/or in the event of load shedding of the battery. The synchronous motor is deactivated in this case for example. Following the deactivation of the synchronous motor, the rotor current is not de-excited immediately. The rotor current is completely de-excited when it has a current intensity of zero ampere. The approach presented here allows a fast and reliable de-excitation of the rotor current using the Id stator current. In this case, following deactivation of the synchronous motor, a positive Id stator current value, which is higher than the Id stator current prior to deactivation, is injected into the stator current. The higher or more positive the Id stator current that is injected, the faster the rotor current is de-excited.

The discharge resistance device 116 can optionally additionally be activated if, for example during the de-excitation of the rotor current, a voltage in the stator current controller 102 exceeds a threshold value, for example a threshold value of 1000 volts. In this case, the discharge resistance device 116 causes a discharge current, in order to protect the device 100 from damage. To this end, the discharge resistance device 116 has the switching equipment 236 and the discharge resistor 246, wherein the switching equipment 236 and the discharge resistor 246 are connected in series according to an exemplary embodiment. The switching equipment 236 is closed so that the voltage from the stator current controller 102 is applied at the discharge resistor 246. If the voltage from the stator current controller 102 is below the threshold value, the switching equipment 236 remains open. The discharge resistance device 116 optionally additionally has a Zener diode. The discharge resistance device 116 additionally has a current measuring device 256 merely by way of example, which is connected in series to the switching equipment 236 and the discharge resistor 246.

The current axes of an electrically excited synchronous motor exhibit very strong transverse coupling. Above all, the currents Id and lexc (=if) have a very strong effect in the respective other axis and therefore interact strongly. For the most part from the transverse coupling, but also due to saturation effects. The Iq current has a clearly smaller transverse coupling effect, slight due to saturation. A clear lexc change in the event of an Id change is known theoretically. An influence of Iq on lexc is dependent on the operating point. A clear lexc change takes place if an Iq change @Id=−100 A for example. A slight lexc change takes place if an Iq change @Id=−300 A for example. The influence of Idq on lexc depends on a change or an increase of a desired value and on a transient response, e.g. overshoots, controller parameters, decoupling, etc.:

$${\vec{u}}_{x} = R \cdot {\vec{ι}}_{x} + \frac{d}{dt} {\vec{Ψ}}_{x} + ω \cdot \underline{J} \cdot {\vec{Ψ}}_{x}$$

$$( \begin{matrix}{U}_{d} \\ {U}_{q} \\ {U}_{\text{?}}\end{matrix} ) = ( \begin{matrix}{R}_{x} & 0 & 0 \\ 0 & {R}_{\text{?}} & 0 \\ 0 & 0 & {R}_{\text{?}}\end{matrix} ) ( \begin{matrix}{I}_{d} \\ {I}_{q} \\ {I}_{\text{?}}\end{matrix} ) + ( \begin{matrix}0 & - ω & 0 \\ ω & 0 & 0 \\ 0 & 0 & 0\end{matrix} ) ( \begin{matrix}{Ψ}_{d} \\ {Ψ}_{q} \\ {Ψ}_{\text{?}}\end{matrix} ) ← \frac{d}{\text{?}} ( \begin{matrix}{Ψ}_{d} \\ {Ψ}_{\text{?}} \\ {Ψ}_{\text{?}}\end{matrix} )$$

$$( \begin{matrix}{Ψ}_{d} \\ {Ψ}_{\text{?}} \\ {Ψ}_{\text{?}}\end{matrix} ) = ( \begin{matrix}{L}_{d} & 0 & {L}_{m} \\ 0 & {L}_{q} & 0 \\ \text{?} {L}_{m} & 0 & {L}_{\text{?}}\end{matrix} ) ( \begin{matrix}{I}_{d} \\ {I}_{q} \\ {I}_{\text{?}}\end{matrix} )$$

$${M}_{LS} = \frac{3}{2} {2}_{p} {I}_{q} ( {L}_{m} {L}_{\text{?}} + ( {L}_{d} - {L}_{q} ) {I}_{d}$$

$$\text{?} \text{indicates text missing or illegible when filed}$$

In other words, current axes of the electrically excited synchronous motor exhibit very strong transverse coupling. That is to say that the currents Id, Iq and lexc have a very strong effect in the respective other axis and therefore interact strongly due to transverse saturation. This effect makes use of the approach presented here, in that a positive Id stator current is injected, the rotor current lexc is de-excited as fast as possible and the e-drive is thereby brought into a safe state. In other words, a positive Id stator current is injected as dynamically as possible by an active control. Due to the steep +di/dt, the rotor current is de-excited to 0 ampere as dynamically as possible. This fast de-excitation, that is to say setting the rotor current lexc to 0 ampere as fast as possible, ensures that no more voltage is induced during rotational operation. The approach presented here relates to an externally electrically excited synchronous motor having a conductive exciter, that is to say having brushes, and having an inductive exciter, that is to say having a transformer.

This is advantageous in a fault case of an e-motor: Here, for the most part an active short circuit, abbreviated to ASC, with high phase currents is actuated or an inverter lockout, abbreviated to IL—all switches open and voltage is induced—is actuated. The first-mentioned case may lead to an impermissibly high rotor current in the case of an externally electrically excited synchronous motor and damage the windings, rotor winding or rectifier diodes. The second-mentioned case may lead to an impermissibly high DC voltage. By means of the approach mentioned, the rotor is de-excited very fast and only subsequently actuated in IL or ASC, as a result of which the two types of damage mentioned can be avoided.

In the case of battery load shedding, in rotational operation, the generative corner point, the battery is disconnected from the drive system. Here, the induced voltage can no longer be stabilized by the battery and the DC link is protected from an impermissibly high DC voltage in the case of IL, in order for example to protect the DC link capacitor, vehicle electronics, etc. By means of the approach that is mentioned, it is possible to avoid a damaging effect in the DC link. In other words, by means of the approach presented here, the rotor is de-excited very fast and subsequently actuated in IL or ASC, without damage occurring.

In other words, in the approach presented here, an active and dynamic adjustment of a positive Id current is carried out in order to de-excite the exciter current lexc=0 A by means of the transverse coupling effect without additional expensive components.

The critical operating point is the generative corner point at which the power is fed into the battery and high negative Id current is present and the battery voltage is at the highest level. If battery load shedding takes place here, the stator control remains active and adjusts the Id current to a high positive d current, the Iq current to 0 ampere and the exciter starts ASC or IL. Until the Id current has changed its sign, the voltage increase in the DC link is discharged for a short time, for two milliseconds maximum, via a parallel discharge resistor to U_dc. As soon as the Id current is positive or the Iq current=0 ampere, feedback is no longer present and the DC link is no longer being charged, the discharge resistor 246 can be disconnected again. Due to the steep +di/dt gradients in the d current, the exciter is additionally de-excited fast.

The point is that one can even drive the d current so far into positive in order to have a positive di/dt that is as large as possible so that the exciter is also actually de-excited completely (l_exc=0 A).

After the fast de-excitation, when U_zk falls slowly, the d current automatically falls slowly in the direction of 0 ampere, the d desired current should also be 0 ampere. As there is no steep gradient here, the exciter current is also not re-excited. Therefore, the uppermost aim of the approach presented here is to set the exciter current, i.e. the rotor current, to 0 ampere as fast as possible and then to stay in this state.

The advantage of the approach presented here is the fast de-excitation of the rotor current, so that the e-motor is in a safe state. For this, no additional components for the rotor are necessary in the case of a conductive exciter. In the case of inductive exciters, only a Zener diode and an additional standard diode are necessary, see FIG. 4. However, this is helpful anyway in order to protect the rotor. Also, a combination of the discharge resistor with a semiconductor for conducting the short circuit current can be used, so that no additional costs are incurred in this case. As due to the fast de-excitation, the resistor only needs to carry the current very briefly in each fault case, for two milliseconds maximum, the resistor can be designed inexpensively or easily.

In other words, the approach presented here enables a transverse coupling of the axes for the rotor de-excitation. The d axis couples very strongly into the lexc exciter axis. Due to a steep positive di/dt in the Id stator current axis, the exciter current can be de-excited completely.

The discharge resistor 246 is activated in hardware. That is to say either by a MOSFET+comparator circuit or directly by a Zener diode. Both elements switch as soon as a critical voltage for the hardware components is reached, for example 1000 volts, because components would be damaged from just this voltage, for example the capacitor. The hardware circuit therefore protects the components in the short time where the Id current changes from negative to positive or increases. The greater the positive Id current gradient (di/dt) is, the faster the rotor current is discharged. The aim is to set the rotor current to 0 ampere as fast as possible.

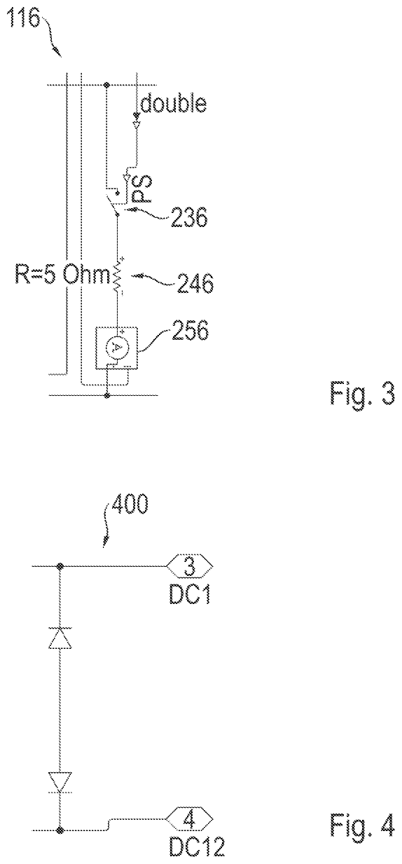

FIG. 3 shows an illustration of a discharge resistance device 116 for an exemplary embodiment of a device. In this case, the discharge resistance device 116 resembles or corresponds to the discharge resistance device from FIG. 1 and/or FIG. 2. More precisely, the discharge resistance device 116 corresponds to the discharge resistance device from FIG. 2.

In other words, FIG. 3 shows necessary hardware. In the case of U_zk, the additional discharge resistor 246 and the switching equipment 236 carry the current only briefly, for two milliseconds maximum, as after that the current pointer is rotated from the generative case to the motor case and then the energy from U_zk flows into the stator winding. This is the difference from the actual U_zk discharge resistor in the case of a permanent magnet synchronous motor, abbreviated PMSM, as in the case of the PMSM, the U_zk is to be discharged completely, but here the voltage peak is only briefly limited. And as it only carries current very briefly, it also does not become as worn/hot as in emergency operation.

FIG. 4 shows an illustration of a diode circuit 400 for an exemplary embodiment of a device. The diode circuit 400 can be arranged merely by way of example in the device, for example the rotor current controller, and designed to protect the further bridge circuit unit of the rotor current controller.

In other words, for a special case of an inductive exciter, FIG. 4 shows two additional diodes for protecting the four rectifier diodes of the further bridge circuit device, see FIG. 1. A Zener diode is necessary so that the current in the rotor current controller also becomes negative as soon as the rotor voltage becomes too large. In the case of a conductive exciter, that would not be a problem, as the rotor current can flow negatively.

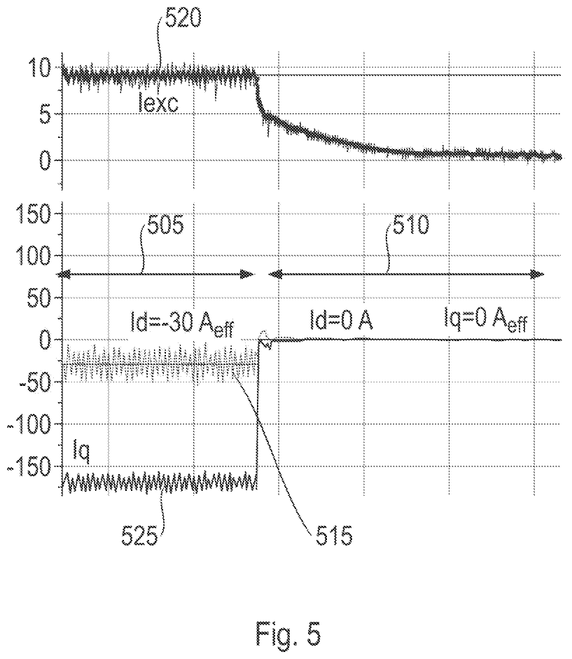

FIG. 5 shows a graph for illustrating signal curves to explain an exemplary embodiment of a device. More precisely, FIG. 5 shows the signal curves during de-excitation of the at least one rotor winding. In other words, FIG. 5 shows a fast de-excitation at 3000 revolutions per minute and an inductive coupling M of −100 newton-meters.

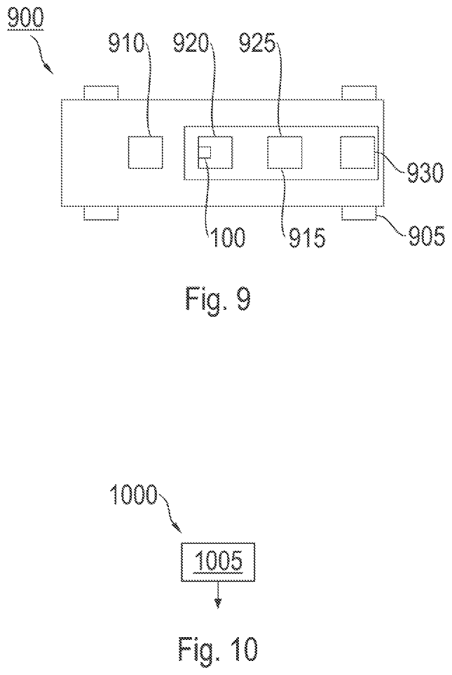

The time is plotted on the abscissa in each case and current intensities in amperes are plotted on the ordinate. In this case, the ordinate is divided into two operating states 505, 510 merely by way of example, wherein the time curves of the operating states 505, 510 are illustrated by means of a double arrow in each case. According to an exemplary embodiment, the first operating state 505, which can also be termed M control, represents a state in which the device or the synchronous motor is in a normal state. In a normal state, the synchronous motor drives a motor vehicle for example, as is illustrated by way of example in FIG. 9. The second operating state 510, which can also be termed rotor ASC, stator-controlled, represents a state in which the de-excitation takes place or a state in which the Id stator current 515 is injected with a positive value.

During the first operating state 505, the rotor current lexc 520 has a current intensity of 10 amperes merely by way of example. The Id stator current 515 has a current intensity of −30 amperes and the Iq stator current 525 has a current intensity of −150 amperes. When the synchronous motor is deactivated, the de-excitation of the rotor current 520 starts, which is indicated by a fall of the rotor current 520 of 10 amperes merely by way of example to initially 5 amperes. In the second operating state 510, the Id stator current 515 is injected at a positive value, here at a value of 0 ampere merely by way of example. Depending on this, the rotor current 520 falls continuously until it reaches a value of 0 ampere and is therefore completely de-excited. In the second operating state 510, the Iq stator current 525 is further injected at a positive value, here likewise at 0 ampere merely by way of example. According to an exemplary embodiment, the Id stator current 515 and the Iq stator current 525 are injected simultaneously at the same positive value, namely 0 ampere. The rotor current 520 is de-excited as a function of the positive injected Id stator current 525. Therefore, the device is in a safe state after a fault case of the synchronous motor.

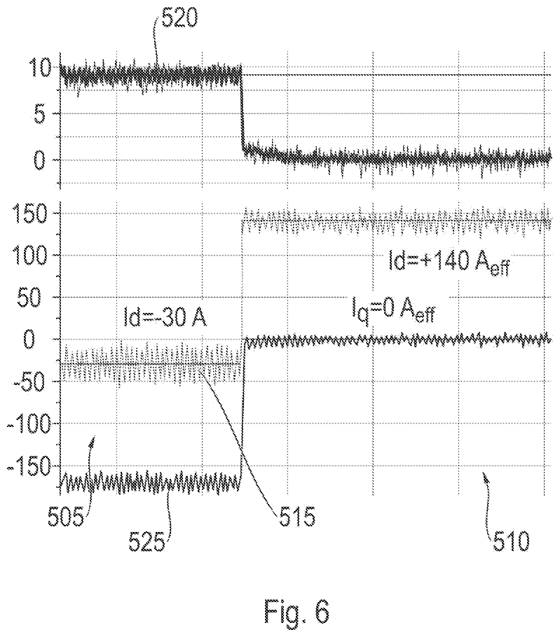

FIG. 6 shows a graph for illustrating signal curves to explain an exemplary embodiment of a device. In this case, the signal curves resemble the signal curves from FIG. 5, with the difference that the Id stator current 515 is injected at a different positive value.

According to an exemplary embodiment, the Id stator current 515 is injected at a positive current intensity of 140 amperes in the second operating state 510. The rotor current 520 is de-excited fast as a function of this, which is illustrated in FIG. 6 in a clear fall of the current intensity of the rotor current 520 from 10 amperes merely by way of example to 0 ampere. Therefore, the higher the Id stator current 515 that is injected, the faster the rotor current 520 is de-excited.

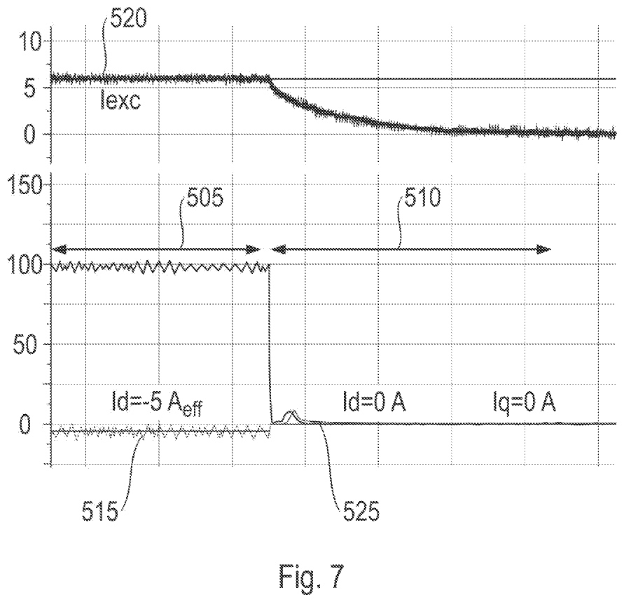

FIG. 7 shows a graph for illustrating signal curves to explain an exemplary embodiment of a device. In this case, the signal curves resemble the signal curves from one of FIGS. 5 and/or 6. More precisely, FIG. 7 shows the signal curves during de-excitation of the at least one rotor winding. In other words, FIG. 7 shows a fast de-excitation at 1000 revolutions per minute and an inductive coupling M of 50 newton-meters.

In the first operating state 505, the rotor current 520 has a current intensity of 6 amperes merely by way of example, the Id stator current 525 has a current intensity of −5 amperes and the Iq stator current 525 has a current intensity of 100 amperes.

In the second operating state 510, the Id stator current 515 is adjusted from −5 amperes to 0 ampere, as a result of which the rotor current 520 falls continuously to 0 ampere, that is to say is de-excited. The Iq stator current 525 is likewise adjusted to 0 ampere at the same time as the Id stator current 515, wherein above all, the Iq stator current 525 is immediately adjusted to 0 ampere.

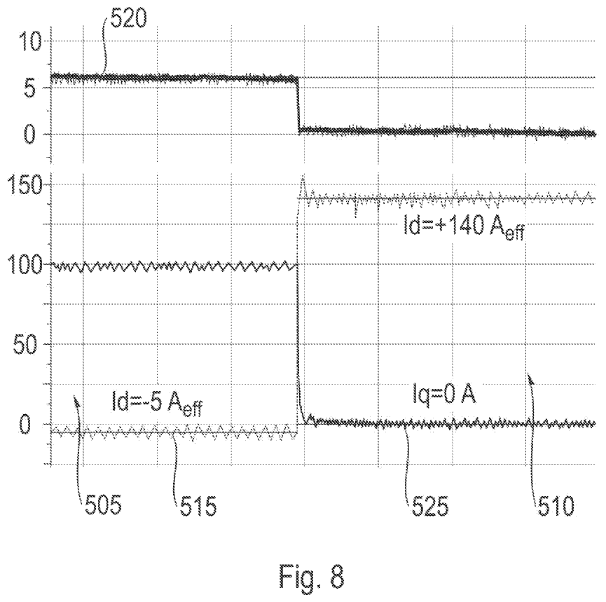

FIG. 8 shows a graph for illustrating signal curves to explain an exemplary embodiment of a device. In this case, the signal curves resemble the signal curves from FIG. 7, with the difference that the Id stator current 525 is injected at a different positive value.

According to an exemplary embodiment, the Id stator current 525 is injected at a positive current intensity of 140 amperes in the second operating state 510. The rotor current 520 is de-excited fast as a function of this, which is illustrated in FIG. 8 in a clear fall of the current intensity of the rotor current 520 from 6 amperes merely by way of example to 0 ampere. Therefore, the higher the Id stator current 515 that is injected, the faster the rotor current 520 is de-excited.

FIG. 9 shows a schematic illustration of an exemplary embodiment of a motor vehicle 900.

Wheels 905, four wheels merely by way of example, an electrical energy storage device 910, for example a battery, and an electric final drive 915 of the motor vehicle 900 are shown here. The electric final drive 915 comprises a power converter 920, a synchronous motor 925 and a transmission device 930.

Electrical energy for operating the synchronous motor 925 is provided by an energy storage device, here the electrical energy storage device 910. The electrical energy storage device 910 is designed to provide direct current, which is converted into an alternating current, for example a three-phase alternating current, using a power converter 920 of the electric final drive 915 and provided to the synchronous motor 925. A shaft that is driven by the synchronous motor 925 is coupled to at least one wheel 905 of the motor vehicle 900 directly or with the use of the transmission device 930. Therefore, the motor vehicle 900 can be moved using the synchronous motor 925. According to an exemplary embodiment, the electric final drive 915 comprises a housing, in which the power converter 920, the synchronous motor 925 and the transmission device 930 are arranged.

According to an exemplary embodiment, the power converter 920 comprises at least one device 100 as is described with reference to the preceding figures. For example, the device 100 is arranged in a DC link of the power converter 920.

FIG. 10 shows a flowchart of an exemplary embodiment of a method 1000 for operating a synchronous motor. Here, the synchronous motor corresponds to or resembles the synchronous motor from one of the figures described herein.

The method 1000 comprises a step 1005 of injecting a stator current at a stator current value. In this case, the stator current is injected at the stator current value in such a manner that a value of an Id stator current following deactivation of the synchronous motor has a predefined positive value. In this case, the positive value is higher than the Id stator current prior to the deactivation.

The exemplary embodiments that are described and shown in the figures are chosen only by way of example. Different exemplary embodiments can be combined with one another completely or with respect to individual features. Also, an exemplary embodiment can be supplemented by features of a further exemplary embodiment.

Furthermore, method steps according to the present disclosure can be performed repeatedly and also in a different sequence from that described.

If an exemplary embodiment includes an “and/or” conjunction between a first feature and a second feature, then this can be read such that the exemplary embodiment according to one embodiment has both the first feature and the second feature and according to a further embodiment has either only the first feature or only the second feature.

### REFERENCE SIGNS

100 Device
102 Stator current controller
103 First pick-off point
104 Rotor current controller
106 Bridge circuit unit
108 Further bridge circuit unit
110 Rotor winding
112 Transformer device
113 Second pick-off point
114 Filter device
116 Discharge resistance device
118 Third half bridge
120 Inductor of the rotor winding
122 First inductor
123 Third energy storage device
124 First supply voltage terminal
126 First half bridge
128 Fourth half bridge
130 Resistor
132 Second inductor
133 Third pick-off point
134 Second supply voltage terminal
136 Second half bridge
142 Further inductor of the transformer device
143 Fourth pick-off point
144 Energy storage device
146 First switch
148 First diode
154 Second energy storage device
156 Second switch
158 Second diode
164 Inductor
166 Third switch
168 Third diode
174 Further inductor
176 Fourth switch
178 Fourth diode
203 Further pick-off point
206 Further switch
216 Additional switch
226 Further half bridge
236 Switching equipment
246 Discharge resistor
256 Current measuring device
400 Diode circuit
505 First operating state
510 Second operating state
515 Id stator current
520 Rotor current
525 Iq stator current
900 Motor vehicle
905 Wheel
910 Electrical energy storage device
915 Electric final drive
920 Power converter
925 Synchronous motor
930 Transmission device
1000 Method for operating a synchronous motor
1005 Injection step

1. A device for de-excitation of at least one rotor winding of an externally electrically excited synchronous motor, the device comprising:
a stator current controller configured to inject a stator current value into a stator current such that a value of an Id stator current following deactivation of the synchronous motor has a predefined positive value and is higher than the Id stator current prior to deactivation.

2. The device as claimed in claim 1, wherein
the stator current controller is configured to inject the stator current such that the value of the Id stator current lies in a tolerance range of 50 percent of a maximum possible Id stator current value.

3. The device as claimed in claim 1, wherein
the stator current controller is configured to inject a stator current value into the stator current such that a value of an Iq stator current has a value of 0 ampere within a tolerance range following deactivation of the synchronous motor.

4. The device as claimed in claim 1, comprising:
a rotor current controller configured to actively short circuit a rotor current of a rotor of the synchronous motor following deactivation of the synchronous motor.

5. The device as claimed in claim 1, wherein
the stator current controller is configured to activate an inverter lockout mode following deactivation of the synchronous motor.

6. The device as claimed in claim 1, comprising:
a discharge resistance device connected between two terminals of a DC link of the synchronous motor in order to cause a discharge current between the terminals of the DC link via a discharge resistor in response to a voltage between the two terminals exceeding a threshold value.

7. The device as claimed in claim 6, wherein
the discharge resistance device is configured to suppress and/or to prevent the discharge current in an event of the voltage between the terminals falling short.

8. The device as claimed in claim 6, wherein the discharge resistance device comprises switching equipment connected in series with the discharge resistor.

9. The device as claimed in claim 8, wherein the switching equipment comprises a MOSFET semiconductor component and a comparator circuit, a thyristor, an IGBT, and/or a Zener diode.

10. An externally electrically excited synchronous motor comprising
the device as claimed in claim 1,
wherein a rotor of the synchronous motor is inductively or conductively electrically coupled or can be inductively or conductively electrically supplied.

11. A power inverter comprising:
the device as claimed in claim 1.

12. An electric final drive for a motor vehicle comprising:
at least one of the synchronous motor as claimed in claim 10;
a transmission device; and
a power converter.

13. A motor vehicle comprising:
the device as claimed in claim 1.

14. A method for operating an externally electrically excited synchronous motor, the method comprising:
injecting a stator current at a stator current value such that a value of an Id stator current following deactivation of the synchronous motor has a predefined positive value that is higher than the Id stator current prior to deactivation.

15. The method as claimed in claim 14, comprising:
injecting a stator current value into the stator current such that a value of an Iq stator current has a value of 0 ampere within a tolerance range following deactivation of the synchronous motor.

16. The method as claimed in claim 14, comprising:
actively short circuiting a rotor current of a rotor of the synchronous motor following deactivation of the synchronous motor.

17. The method as claimed in claim 14, comprising:
activating an inverter lockout mode following deactivation of the synchronous motor.

18. The method as claimed in claim 14, comprising:
causing a discharge current between two terminals of a DC link of the synchronous motor via a discharge resistor of a discharge resistance device connected between the two terminals in response to a voltage between the two terminals exceeding a threshold value.

19. The method as claimed in claim 18, comprising:
suppressing and/or preventing the discharge current by the discharge resistance device in response to the voltage between the terminals falling short.

20. A non-transitory computer readable medium having stored thereon a computer program that, when executed by at least one processing device, causes the at least one processing device to execute a method comprising:
injecting a stator current at a stator current value such that a value of an Id stator current following deactivation of a synchronous motor has a predefined positive value that is higher than the Id stator current prior to deactivation.
